(19) United States
(12) Patent Application Publication
(10) Pub. No.: US 2026/0087700 A1
(43) Pub. Date: Mar. 26, 2026

(54) GENERATIVE ARTIFICIAL INTELLIGENCE (AI) MANAGER SYSTEM

(71) Applicant: Adobe Inc., San Jose, CA (US)

(72) Inventors: Christopher James Gammon, Waunakee, WI (US); Vikas Yadav, Seattle, WA (US); Timothy W. Kukulski, Oakland, CA (US); Peitong Chen, Cambridge, MA (US); Kelsey Smith, Denver, CO (US); Gregory Cy Muscolino, Novato, CA (US); Eric P. Snowden, San Francisco, CA (US); Daniela Caicedo Rodriguez, Brooklyn, NY (US)

(73) Assignee: Adobe Inc., San Jose, CA (US)

(21) Appl. No.: 19/030,521

(22) Filed: Jan. 17, 2025

Related U.S. Application Data
(60) Provisional application No. 63/698,848, filed on Sep. 25, 2024.

(51) Int. Cl. G06T 11/60; G06F 3/0482; G06F 3/04847; G06F 9/451

(52) U.S. Cl. CPC G06T 11/60; G06F 3/0482; G06F 3/04847; G06F 9/452; G06T 2200/24

(57) ABSTRACT

Generative artificial intelligence (AI) manager system techniques are described. In one or more implementations, input image data is received from a frame buffer. The input image data describes pixels displayed on a display device. A prompt is formed for processing using generative artificial intelligence (AI) by a machine-learning model. Generative digital content is obtained from the machine-learning model responsive to the prompt. The generative digital content is presented for display in a user interface concurrently with at least a portion of the pixels.

### RELATED APPLICATIONS

This application claims priority under 35 U.S.C. Section 119(e) to U.S. Provisional Patent Application No. 63/698,848, filed Sep. 25, 2024, and titled “Generative Artificial Intelligence (AI) Manager System,” the entire disclosure of which is hereby incorporated by reference in its entirety.

### BACKGROUND

Generative artificial intelligence (AI) is implemented using machine-learning models to generate digital content based on prompts. The machine-learning models, for instance, are trainable based on a variety of training inputs to produce a wide range of digital content, examples of which include text, digital audio, digital images, and so forth. Further, each of these different examples is also achievable using a corresponding range of functionalities, for which, the models are trained. As a result, there are a multitude of machine-learning models configurable to implement a multitude of different generative techniques.

Conventional techniques used to implement generative artificial intelligence, however, are inflexible and often involve specialized knowledge in order to achieve a desired result. Accordingly, conventional techniques may fail in a variety of scenarios to adapt to ever increasing changes used to implement this functionality, differences in the functionalities made available by these changes, and result in inefficient use of computational resources in order to achieve the desired result.

### SUMMARY

Generative artificial intelligence (AI) manager system techniques are described. The generative AI manager system is configured to act as an interface between a variety of content edition applications and machine-learning models used to implement generative artificial intelligence for a variety of digital content types. The generative AI manager system, for instance, may leverage a frame buffer to collect input image data from a content editing application without directly interacting with the application. In this way, through use of the generative AI manager system, a creative may work in a familiar content-editing environment to create digital content and yet incorporate generative digital content as part of that environment.

A variety of other functionalities are also implementable by the generative AI manager system in support of generative artificial intelligence management. Examples include use of a frame buffer in support of operation in conjunction with a content editing application without modification of the application or even direct access to the application, an ability to control an amount of fidelity the machine-learning model applies to the input image data and/or the text input, selection of the machine-learning models from a plurality of candidate machine-learning models to provide corresponding functionality, use of the input image data as a layer with the generative digital content being included as an additional layer in the digital content of the content editing application, automatic generative digital content generation based on detected edits to the digital content of the content editing application, and so forth.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ generative artificial intelligence (AI) manager system techniques described herein.

FIG. 2 depicts a system in an example implementation showing operation of a generative AI manager system of FIG. 1 in greater detail as selecting an option for generation of input image data for use in a prompt to a machine-learning model.

FIG. 3 depicts a system in an example implementation showing operation of a generative AI manager system of FIG. 1 in greater detail as initiating generation of generative digital content using a prompt based at least in part of the input image data.

FIG. 4 depicts a system in an example implementation showing operation of a generative AI manager system of FIG. 1 in greater detail as initiating generation of generative digital content using a prompt including an edit to the input image data from the digital content.

FIG. 5 depicts a system in an example implementation showing operation of a generative AI manager system of FIG. 1 in greater detail as initiating generation of generative digital content through an edit as continuing with the example of FIG. 4.

FIG. 6 depicts a system in an example implementation showing operation of a generative AI manager system of FIG. 1 in greater detail as initiating generation of generative digital content based on a layer received an input image data.

FIG. 7 is a flow diagram depicting an algorithm as a step-by-step procedure in an example implementation of operations performable for accomplishing a result of generative ratification intelligence (AI) management.

FIG. 8 illustrates an example system including various components of an example device that can be implemented as any type of computing device as described and/or utilize with reference to the previous figures to implement embodiments of the techniques described herein.

### DETAILED DESCRIPTION

### Overview

Generative artificial intelligence (AI) is usable to produce a wide range of digital content using an equally wide range of machine-learning models trained using a variety of types of training data. Conventional techniques used to implement generative AI, however, are fractured, inconsistent, and often involve use of specialized functionality to interact with particular machine-learning models in different scenarios. Consequently, conventional techniques are ill suited for use by casual users and involve learning specialized knowledge even by sophisticated users, which is time and computationally resource intensive.

Accordingly, a generative artificial intelligence (AI) manager system is described. The generative AI manager system is configured to bridge use of a variety of content edition applications and machine-learning models used to implement generative artificial intelligence for a variety of digital content types. The generative AI manager system is configurable to do so in a variety of ways, examples of which include a plug-in module, standalone application (e.g., as part of a digital service), and so forth. Through use of the generative AI manager system, a creative may work in a familiar content-editing environment of a content editing application to create digital content using well-understood tools and operations and yet incorporate generative digital content as part of that environment, which is not possible in conventional techniques. The generative AI manager system is configurable in various ways to achieve this functionality.

In one or more examples, a content editing application is executed by a computing device to edit digital content, e.g., a digital image. As part of this, the content editing application outputs a user interface including a display of the digital image as well as representations of functionality (e.g., operations) usable to edit the digital image. The generative AI manager system is also executed in this example and may do so as a standalone application (e.g., locally or part of a digital service), plug-in module (e.g., that is “deeply” integrated with the content editing application), and so forth. The generative AI manager system also outputs a user interface (e.g., via a respective window separate from a window used by the content editing application), which in this instance supports generative AI techniques to create generative AI digital content.

The generative AI manager system, for instance, is configurable to receive an input to specify a source of input image data that is to be used as part of a prompt for processing using generative AI. Examples of options usable to do so include “full screen,” “select window,” “custom size,” a particular “application” that is being executed by the computing device, and so on.

In one or more implementations, the generative AI manager system is configured to support operation with a variety of different content editing applications. To do so in at least one example, the generative AI manager system is configured to leverage a frame buffer to support communication with data generated by the content editing applications. Selection of an option involving “full screen,” “select window,” and/or “custom size” (e.g., using a “snip”), for instance, causes the generative AI manager system to obtain pixel data from the frame buffer corresponding to the selected option. Similar functionality may also be utilized for the “application” option. As a result, the generative AI manager system is configurable to obtain the input image data without modification to the content editing application and even without direct communication with the content editing application itself and therefore is operable with a wide range of legacy applications.

The input image data is usable in this example by the generative AI manager system to generate a prompt for processing by a machine-learning model. The input image data, for instance, may include a freehand drawing, arrangement of clipart, and so on taken from pixels of the frame buffer as rendered in a window through execution of the content editing application. The input image data therefore provides a context as part of the prompt for generation of digital content using generative AI. The prompt is also configurable to include additional context, such as text data describing parameters usable to specify characteristics to be included as part of the generative digital content.

The input image data, for instance, may include a colored foreground, a hand drawing of triangles, and a circle to represent position of mountains and a sun in relation to a field. The text data may also specify characteristics to be used in generating the scene depicted in the input image data, e.g., “sun rising over a snowy mountain range in front of grassy plains.”

Generative digital content generated by the machine-learning model is then output in this example in a window associated with the generative AI manager system for review. Continued edits may be made to the digital content output by the content editing application, the text input, and so forth to achieve a desired result. Once achieved, the generative AI manager system includes an option to communicate the generative digital content back to the content editing application, e.g., for output in a window associated with the content editing application.

As a result, the generative AI manager system may seamlessly interact with the content editing application to expand accessibility of generative AI capabilities. The generative AI manager system is also configurable to incorporate a wide range of additional functionalities. Examples of these functionalities include an ability to control an amount of fidelity the machine-learning model applies to the input image data and/or the text input, selection of the machine-learning models from a plurality of candidate machine-learning models to provide corresponding functionality, use of the input image data as a layer with the generative digital content generated based on that layer included as an additional layer in the digital content of the content editing application, automatic generative digital content generation based on detected edits to the digital content of the content editing application, and so forth. In this way, the generative AI manager system supports authoring in native content editing applications using well-understood tools to expand inclusion of generative AI functionalities. Further discussion of these and other examples are included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

“Generative AI” models are machine-learning models trained to generate digital content such as text, digital images, digital audio, executable code, and so forth. Examples of generative AI models include Adobe® Firefly®, GPT-4, Dall-E 2, StyleGAN2, MusicLM, Codex, and so forth. A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Generative AI Management Environment

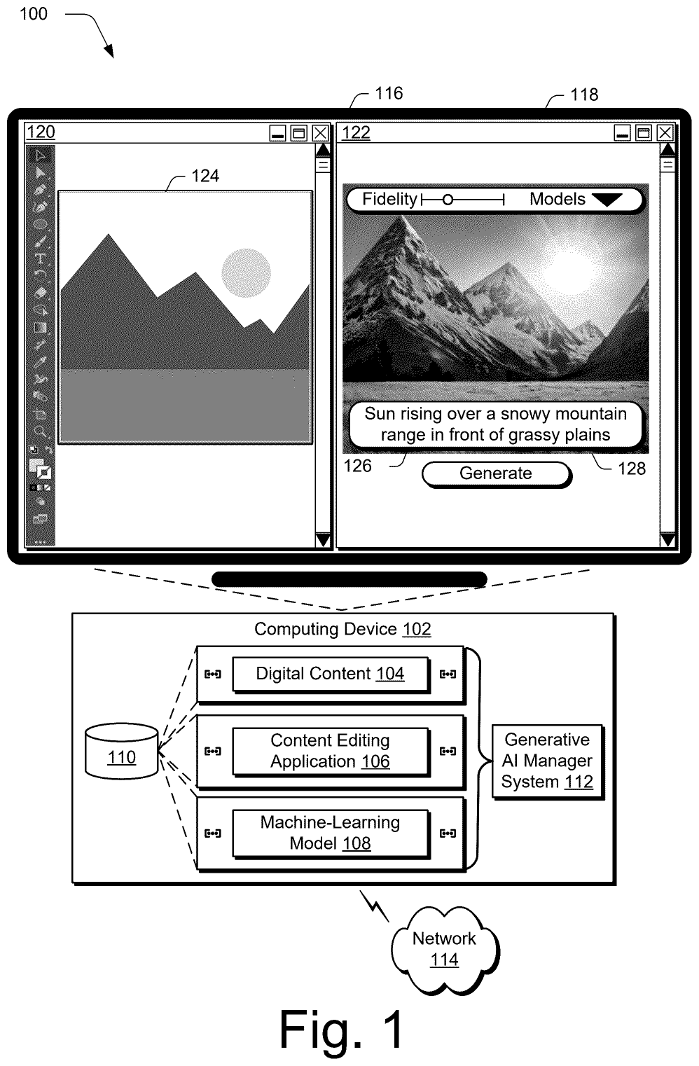

FIG. 1 is an illustration of a digital medium environment 100 in an example implementation that is operable to employ generative artificial intelligence (AI) manager system techniques described herein. The illustrated environment 100 includes a computing device 102, which is configurable in a variety of ways.

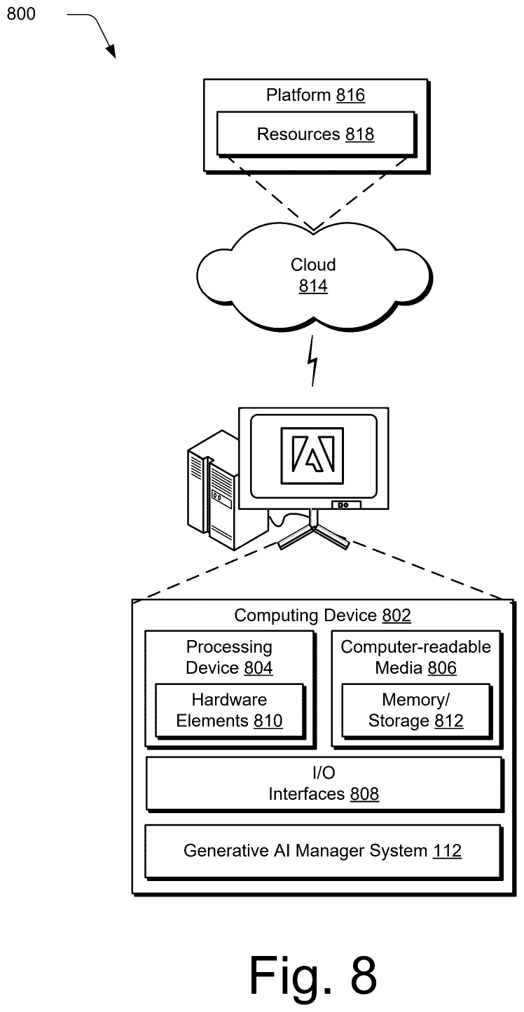

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” as further described in relation to FIG. 8.

The computing device 102 is illustrated as including one or more items of digital content 104, at least one content editing application 106, and at least one machine-learning model 108, each of which are illustrated as maintained in a storage device 110 (e.g., a computer-readable storage medium) and are executable by a processing device. Examples of digital content 104 include digital images, digital documents, digital presentations, email, instant messages, digital audio, digital video, digital media, and so forth.

Examples of functionality includable in a content editing application 106 include an ability to edit the digital content 104, which includes creation of digital content 104 “from scratch,” edits to existing digital content 104, and so forth. The machine-learning model 108 is representative of functionality usable to implement generative artificial intelligence. Generative AI, as previously described, refers to a type of artificial intelligence that can create digital content 104, such as text, images, or music, based on training data. The machine-learning model 108 is configured to implement algorithms (e.g., using a neural networks) to learn patterns and structures from the training data, e.g., positive and negative examples with corresponding prompts as “ground truth” examples. Once trained, the machine-learning model 108 is configured to generate digital content by predicting and assembling elements in a coherent way based on a prompt.

As previously described, conventional techniques used to implement generative AI are fractured and inconsistent often involving use of specialized functionality to interact with particular machine-learning models in different scenarios. Consequently, conventional techniques are ill suited for use by casual users and involve learning specialized knowledge even by sophisticated users, which is time and computationally resource intensive.

In the illustrated example, the computing device 102 implements a generative artificial intelligence (AI) manager system (depicted as generative AI manager system 112) to act as a bridge between the content editing application 106 and machine-learning model 108 used to implement generative artificial intelligence for a variety of types of digital content 104. The generative AI manager system 112 is configurable to do so in a variety of ways, examples of which include a plug-in module, a standalone application executed locally at the computing device 102, as part of a digital service accessible remotely via a network 114, and so forth.

As depicted in an example user interface 116 displayed by a display device 118 of the computing device 102, a first window 120 is rendered based on an output from the content editing application 106 and a second window 122 is rendered based on an output of the generative AI manager system 112. The first window 120 includes a display of a digital image 124 that is drawn using one or more operations implemented by the content editing application 106. As a result, a user may work in a familiar content-editing environment of the content editing application 106 to create digital content using well-understood tools and operations and yet incorporate generative digital content as part of that environment, which is not possible in conventional techniques.

The display of digital image 124 is usable in this example along with a text input 126 (e.g., “sun rising over a snowy mountain range in front of grassy plains”) to generate a prompt by the generative AI manager system 112. The prompt is then passed as an input to a machine-learning model 108 to generate generative digital content 128, which is displayed in the second window 122 associated with the generative AI manager system 112.

The generative digital content 128, as illustrated includes objects that follow objects defined in a digital image 124 and have characteristics as defined by the digital image 124 and/or the text input 126. The mountain range, for instance, includes mountains having peaks that follow peaks of the digital image 124, a depiction of a sun at a corresponding location of a circle in the digital image 124 with a grassy plain in a forefront. In this way, the digital content 104 and text input 126 provide precise guidance as to how the generative digital content 128 is to be generated by the machine-learning model 108 using readily understood operations of the content editing application 106.

The generative digital content 128, once produced, is selectable for communication by the second window 122 to the content editing application 106 for display in the first window 120 as part of the digital image 124. Thus, in this example the digital image 124 is displayable jointly with the generative digital content 128 generated by the machine-learning model 108 through use of the generative AI manager system 112.

A variety of functionalities may be implemented by the generative AI manager system 112 in support of generative artificial intelligence management. Examples include use of a frame buffer in support of operation in conjunction with a content editing application 106 without modification of the application or even direct access to the application, an ability to control an amount of fidelity the machine-learning model applies to the input image data and/or the text input, selection of the machine-learning models from a plurality of candidate machine-learning models to provide corresponding functionality, use of the input image data as a layer with the generative digital content being included as an additional layer in the digital content of the content editing application, automatic generative digital content generation based on detected edits to the digital content of the content editing application, and so forth. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Generative AI Manager System Operation

The following discussion describes generative AI manager system techniques that are implementable utilizing the described systems and devices. The generative AI manager system is configured to bridge use of a variety of content edition applications and machine-learning models used to implement generative artificial intelligence for a variety of digital content types.

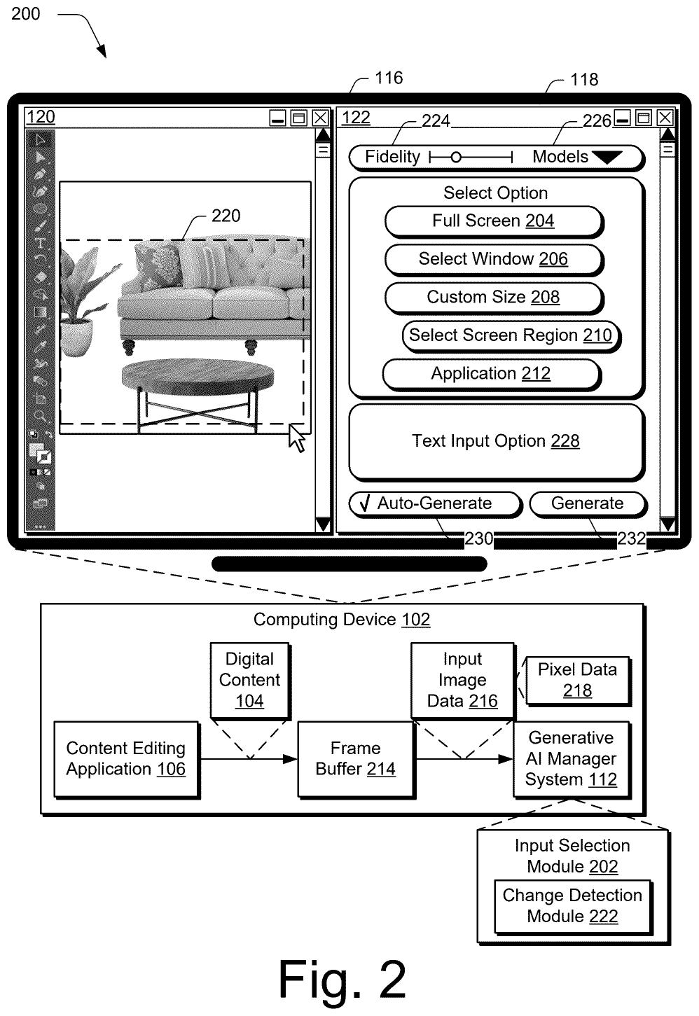

FIG. 2 depicts a system 200 in an example implementation showing operation of a generative AI manager system of FIG. 1 in greater detail as selecting an option for generation of input image data for use in a prompt to a machine-learning model 108. The user interface 116 as displayed by the display device 118 of the computing device 102 includes a first window 120 corresponding to the content editing application 106 and a second window 122 corresponding to the generative AI manager system 112.

The second window 122 includes a display of a plurality of options output by an input selection module 202 of the generative AI manager system 112. The options are usable to define “how” and “what” image data is to be obtained for inclusion in a prompt. Examples of the options include a full screen option 204 usable to indicate a particular screen (i.e., a display device 118) to be used as a whole. The options also include a select window 206 option to select a particular window, e.g., the first window 120. Additional examples include a custom size 208 option to select a particular portion of a window, screen, and so forth. The custom size 208, for example, is usable to select a screen region 212 of the user interface 116, e.g., by drawing a box through a click-and-drag operation using a cursor control device. An application 210 option is also included to select a particular application's output, e.g., through use of a dropdown menu having options of applications that are currently being executed and/or available for execution by the computing device 102.

Once selected, the generative AI manager system 112 is configured to access a frame buffer 214 to receive input image data 216 that is to be used as a basis for generation of the generative digital content. The generative AI manager system 112, for instance, accesses the frame buffer 214 to obtain pixel data 218 including color values of pixels included in a respective selection option, i.e., a full screen, select window, selected screen region, application size, and so forth. In the illustrated example, a cursor control device is utilized to draw a bounding box 220 around a portion of the digital content 104 displayed in the first window 120 by the content editing application 106. The generative AI manager system 112, in response, copies the pixel data 218 from the frame buffer 214 into a respective image file, thereby forming the input image data 216.

As a result, the generative AI manager system 112 is configurable to obtain the input image data 216 as created by the content editing application 106 without directly accessing the content editing application 106, thereby promoting use with legacy applications. Other examples are also contemplated, including direct access, e.g., as a plugin module. Other detection examples are also contemplated. The generative AI manager system 112, for instance, is configurable to include a change detection module 222 that is configured to detect when a change is made to the digital content 104 and in response copy the pixel data 218 from the frame buffer 214 corresponding to the change (e.g., the digital content 104 itself) as input image data 216.

A variety of additional options are included in the second window 122 output by the generative AI manager system 112 to control generation of the generative digital content. A fidelity 224 option is included to specify a relative amount of fidelity the machine-learning model 108 is to give to the input image data 216. A slider control, for instance, is illustrated that is used to constrain how closely the generative digital content matches characteristics of the input image data 216. This amount is then includable as part of a prompt communicated by the generative AI manager system 112 to the machine-learning model 108.

A models 226 option is also included in the user interface 116 that is configurable to select a particular machine-learning model from a plurality of candidate machine-learning models. This selection is then includable as part of a prompt communicated by the generative AI manager system 112 to the machine-learning model 108. The selection may be performed manually through user interaction as illustrated and/or by the generative AI a manger system 112, automatically and without user intervention. The generative AI manager system 112, for instance, may select the model through processing of the input image data and/or a text prompt using a machine-learning model trained to identify a goal from this data. The plurality of candidate machine-learning models, for instance, are configurable to employ different training data or techniques usable to form a particular type of generative digital content, select from a plurality of types of digital content, and so forth.

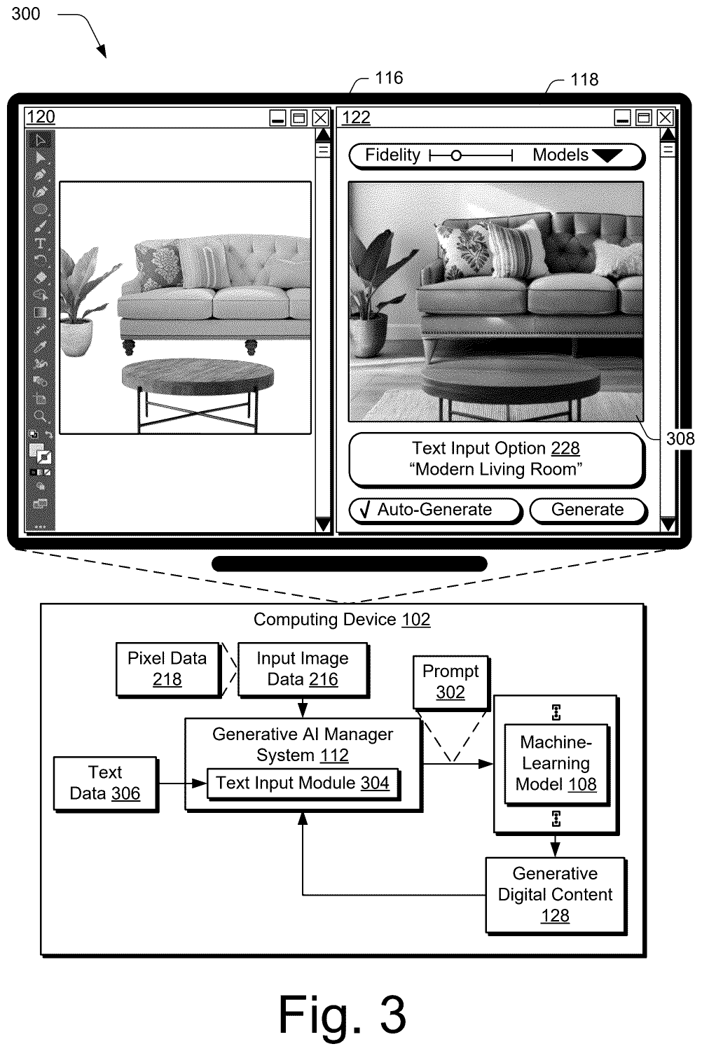

A text input option 228 is also included as a option to input text data usable to guide the machine-learning model, e.g., as part of a prompt as further described in relation to FIG. 3. Options are also included that are usable to control when the digital content is generated, examples of which include an auto-generate 230 option usable to cause generation of the generative digital content automatically and without user intervention responsive to receipt of inputs by the generative AI manager system 112, e.g., the input image data 216 and/or text input data. A generate 232 option is also included that is manually selectable via the second window 122 of the user interface 116 to initiate digital content generation by a machine-learning model.

FIG. 3 depicts a system 300 in an example implementation showing operation of a generative AI manager system of FIG. 1 in greater detail as initiating generation of generative digital content using a prompt based at least in part of the input image data 216. The generative AI manager system 112 as previously described is configured to bridge functionality of the content editing application 106 with the machine-learning model 108 in order to support generative AI. To do so in these examples, the input image data 216 is collected by the generative AI manager system 112 as described in relation to FIG. 2, which may include pixel data 218. The generative AI manager system 112 is then tasked with forming a prompt 302 to cause the machine-learning model 108 to initiate generation by the machine-learning model 108 of the generative digital content 128.

In this example, the generative AI manager system 112 also includes a text input module 304 that is configured to receive text data 306 usable to further guide generation of the generative digital content 128 by the machine-learning model 108. As illustrated, the text input option 228 received text data 306 of “modern living room.” The text data 306 is includable with the input image data 216 as part of the prompt 302 that is then used to guide operation of the machine-learning model 108.

The machine-learning model 108, for instance, is configurable as a generative adversarial network, a multimodal diffusion model, or other architecture that is trained used training data including text and/or digital images to generate digital content using generative AI. The generative digital content 128, once generated, is passed from the machine-learning model 108 (e.g., locally or remotely via the network 114) back to the generative AI manager system 112. In the illustrated example 308, the generative digital content 128 is displayed in the second window 122 concurrently with at least a portion of the input image data 216 taken from the first window 120 used as a basis for the prompt 302. Subsequent edits may then be made with an effect of those edits automatically populated to the generative digital content 128 as further described in the following example.

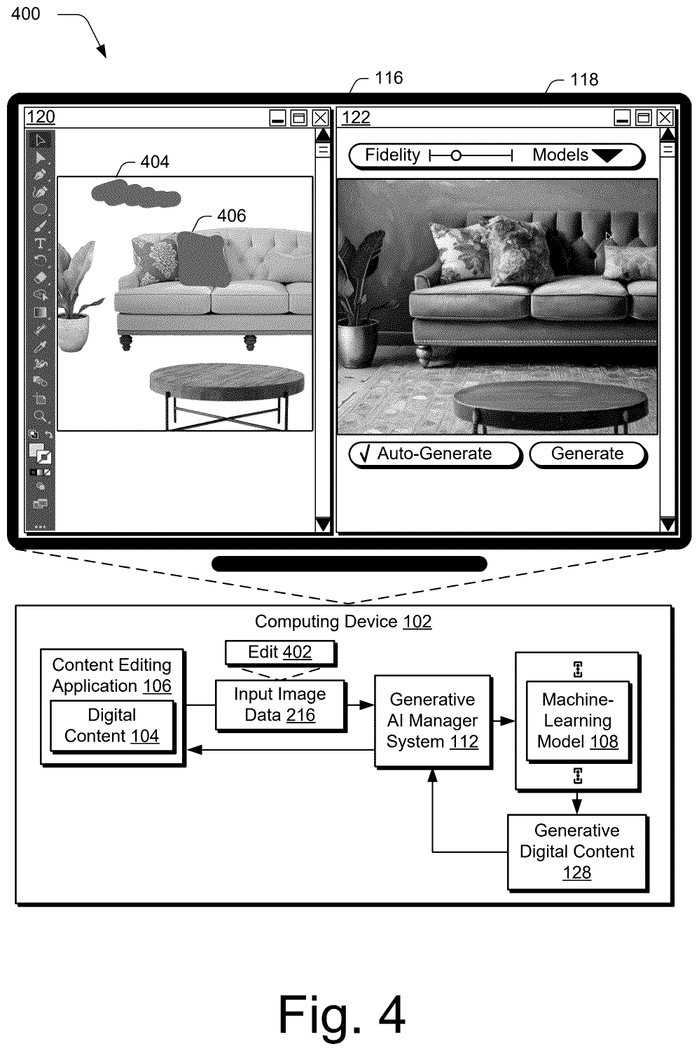

FIG. 4 depicts a system 400 in an example implementation showing operation of a generative AI manager system of FIG. 1 in greater detail as initiating generation of generative digital content using a prompt including an edit to the input image data 216 from the digital content 104. In this example, an edit 402 is made through interaction with the content editing application 106, a first example 404 of which includes color applied to a wall area and a second example 406 include recoloring a pillow on the couch.

In response, the generative AI manager system 112 tasks the machine-learning model 108 with generating the generative digital content 128 to include those changes. A result of which is then output in the second window 122 associated with the generative AI manager system 112. Thus, a real time editing process is supportable by the generative AI manager system 112 to make edits to digital content 104 and view an effect of those edits on generation of the generative digital content 128.

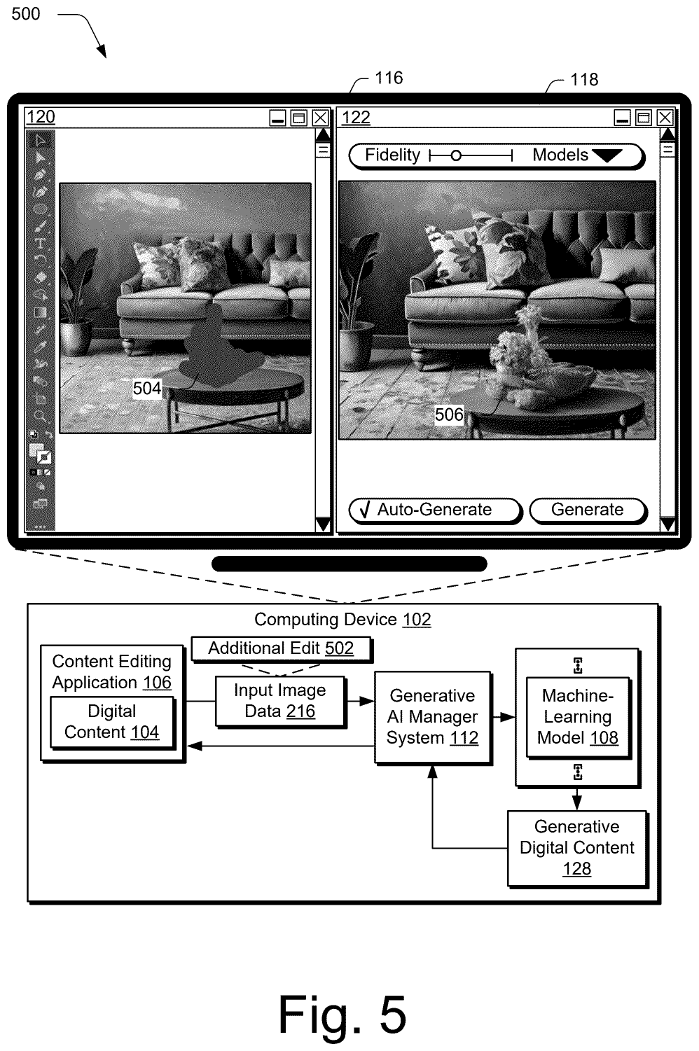

FIG. 5 depicts a system 500 in an example implementation showing operation of a generative AI manager system of FIG. 1 in greater detail as initiating generation of generative digital content through an edit as continuing with the example of FIG. 4. In this example, an additional edit 502 is received that is used to modify the generative digital content 128 by the content editing application 106 are received from the machine-learning model 108 via the generative AI manager system 112. An example 504 of the additional edit 502 includes color providing an outline of an object placed on the coffee table.

In response, the generative AI manager system 112 forms a prompt including the additional edit 502 which is then used to generate generative digital content 128 having one or more objects 506 at the specified location. An option may then be output to replace toe generative digital content 128 displayed in the second window 122 with the previously generated digital content in the first window 120 associated with the first window 120, e.g., via an application programming interface.

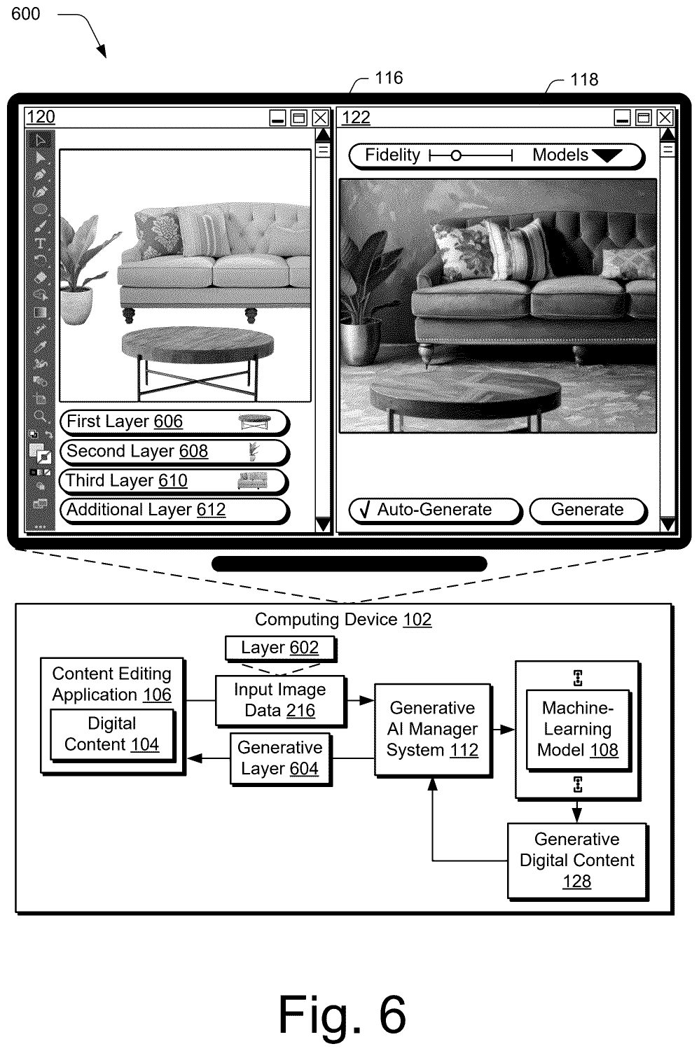

FIG. 6 depicts a system 600 in an example implementation showing operation of a generative AI manager system of FIG. 1 in greater detail as initiating generation of generative digital content based on a layer received an input image data. As previously described, the input image data 216 may take a variety of forms. In this example, the input image data 216 includes a layer 602 taken from a digital image as an example of digital content 104. A generative layer 604 is then provided as a response to the input image data 216.

“Layers” and “layering” refer to techniques used by content editing application 106 to work on different parts of a digital image separately without affecting other parts of the images, i.e., other layers. These techniques are usable to support non-destructive editing, ordering (e.g., a z-ordering of objects), blending and opacity, masks, use as adjustment layers, styles, compositing, and so forth.

In the illustrated example, for instance, the digital content 104 includes a first layer 606 (e.g., corresponding to a coffee table), a second layer 608 (e.g., corresponding to a plant), and a third layer 610, e.g., corresponding to a couch. One or more of these layers are selected as the input image data input image data 216, which is then used to generate generative digital content 128 as previously described.

In this example, however, the generative digital content 128 is communicated by the generative AI manager system 112 as a generative layer 604 that is included as an additional layer 612 as part of the digital content 104. In this way, the generative layer 604 may be included to support separate editing using the content editing application 106 and thus provide a seamless experience which is not possible in conventional techniques.

### Example Generative AI Management Procedures

Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

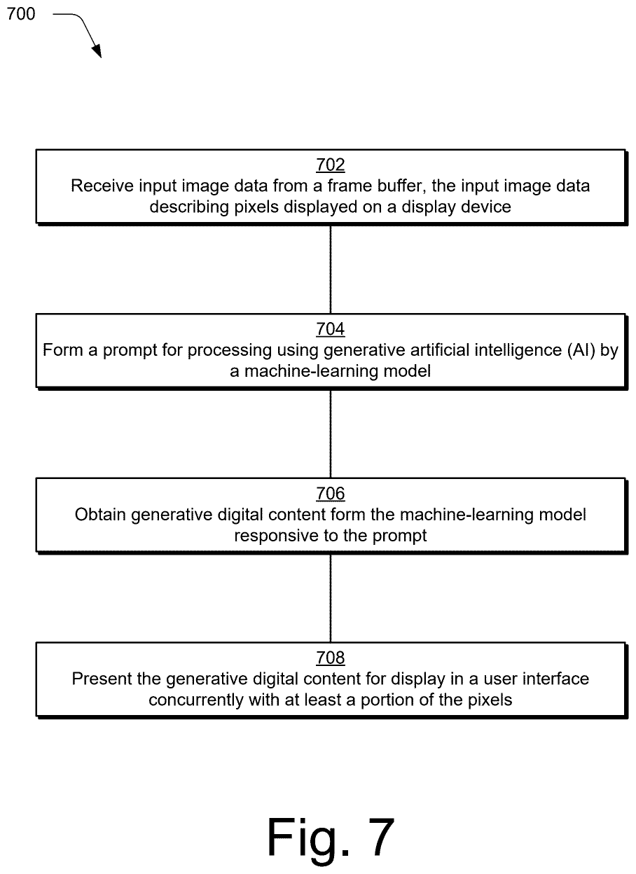

FIG. 7 is a flow diagram depicting an algorithm 700 as a step-by-step procedure in an example implementation of operations performable for accomplishing a result of generative ratification intelligence (AI) management. To begin in this example, input image data is received from a frame buffer. The input image data describes pixels displayed on a display device (block 702). A prompt is formed for processing using generative artificial intelligence (AI) by a machine-learning model (block 704). Generative digital content is obtained from the machine-learning model responsive to the prompt (block 706). The generative digital content is presented for display in a user interface concurrently with at least a portion of the pixels (block 708).

### Example System and Device

FIG. 8 illustrates an example system generally at 800 that includes an example computing device 802 that is representative of one or more computing systems and/or devices that implement the various techniques described herein. This is illustrated through inclusion of the generative AI manager system 112. The computing device 802 is configurable, for example, as a server of a service provider, a device associated with a client (e.g., a client device), an on-chip system, and/or any other suitable computing device or computing system.

The example computing device 802 as illustrated includes a processing device 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 804 is representative of functionality to perform one or more operations using hardware. Accordingly, the processing device 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812 that stores instructions that are executable to cause the processing device 804 to perform operations. The computer-readable storage medium is configured for storing instructions that, responsive to execution by the processing device, causes the processing device to perform operations. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

In implementations, the platform 816 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, input image data from a frame buffer, the input image data describing pixels displayed on a display device;
forming, by the processing device, a prompt based on the input image data for processing using generative artificial intelligence (AI) by a machine-learning model;
obtaining, by the processing device, generative digital content from the machine-learning model responsive to the prompt; and
presenting, by the processing device, the generative digital content for display in a user interface concurrently with at least a portion of the pixels.

2. The method as described in claim 1, wherein the pixels are rendered to the frame buffer through execution of a standalone content editing application.

3. The method as described in claim 2, further comprising communicating the generative digital content to the standalone content editing application for display in a window associated with the standalone content editing application that includes the pixels, the communicating performed from a window associated with the presenting.

4. The method as described in claim 1, wherein the receiving, the forming, the obtaining, and the presenting are performed, automatically and without user intervention, in real time responsive to detecting an edit to digital content associated with the pixels as displayed in the user interface.

5. The method as described in claim 4, further comprising communicating the generative digital content, automatically and without user intervention, for display in a window in the user interface associated with a source of the input image data.

6. The method as described in claim 1, further comprising receiving text data describing the generative digital content to be generated and wherein the forming of the prompt includes the text data.

7. The method as described in claim 6, further comprising selecting the machine-learning model from a plurality of candidate machine learning models based on the input image data, the text data, or a user selection.

8. The method as described in claim 1, further comprising presenting a plurality of options specifying a source of the input image data and wherein the receiving is performed using a select option from the plurality of options.

9. The method as described in claim 8, wherein the plurality of options includes a full screen option, a select window option, a select screen region option, or an application option usable to select a content editing application.

10. The method as described in claim 1, further comprising presenting a control that is user selectable via the user interface to specify an amount of fidelity to be applied by the machine-learning model in generating the generative digital content and wherein the prompt includes the amount.

11. The method as described in claim 1, wherein the pixels correspond to a layer of digital content and wherein the presenting of the generative digital content is added as an additional layer to the digital content.

12. A system comprising:
a content editing application executable by a processing device to edit digital content and display the digital content in a content-editing window in a user interface;
one or more machine-learning models configured to implement generative artificial intelligence to produce generative digital content as a digital image; and
a generative artificial intelligence (AI) manager system executable by the processing device to perform operations including:
receiving input image data rendered from digital content associated with the standalone content editing application;
forming a prompt for processing by the one or more machine-learning models to produce the generative digital content based in the input image data;
displaying the generative digital content in a generative window in the user interface; and
communicating the generative digital content generated by the one or more machine-learning models to the standalone content editing application for inclusion in the content-editing window.

13. The system as described in claim 12, wherein the operations of the generative artificial intelligence manager system further include receiving text data describing the generative digital content to be generated and wherein the forming of the prompt includes the text data.

14. The system as described in claim 12, wherein the operations of the generative artificial intelligence manager system further include selecting the machine-learning model from a plurality of candidate machine learning models based on the input image data or text data entered via a user interface describing the generative digital content to be generated.

15. The system as described in claim 12, wherein the operations of the generative artificial intelligence manager system further include detecting an edit to the digital content and wherein the receiving is performed automatically and without user intervention responsive to the detecting.

16. One or more computer-readable storage media storing instructions that, responsive to execution by a processing device, causes the processing device to perform operations comprising:
receiving input image data as at least one layer taken from digital content displayed in a user interface;
forming a prompt that includes the at least one layer for processing using generative artificial intelligence (AI) by a machine-learning model;
obtaining generative digital content from the machine-learning model responsive to the prompt; and
communicating the generative digital content to a source of the digital content as an additional layer for inclusion as part of the digital content and display in the user interface.

17. The one or more computer-readable storage media as described in claim 16, wherein the digital content is displayed in a content-editing window and the communicating causes the generative digital content to be added to the content-editing window as the additional layer.

18. The one or more computer-readable storage media as described in claim 17, the operations further comprising displaying the generative digital content in a window separate from the content-editing window responsive to the obtaining and before the communicating.

19. The one or more computer-readable storage media as described in claim 16, the operations further comprising presenting a control that is user selectable via the user interface to specify an amount of fidelity to be applied by the machine-learning model in generating the generative digital content and wherein the prompt includes the amount.

20. The one or more computer-readable storage media as described in claim 16, the operations further comprising detecting an edit to the at least on layer of the digital content and wherein the receiving is performed automatically and without user intervention responsive to the detecting.
